(19) United States
(12) Patent Application Publication
(10) Pub. No.: US 2026/0064861 A1
(43) Pub. Date: Mar. 5, 2026

(54) DEVICE, METHOD, AND COMPUTER PROGRAM FOR SECURING DIAGNOSTIC DATA

(71) Applicant: Infineon Technologies AG, Neubiberg (DE)

(72) Inventors: Gasper SKVARC BOZIC, Unterhaching (DE); Alexander ZEH, München (DE); Patrik EDER, Taufkirchen (DE)

(21) Appl. No.: 19/287,352

(22) Filed: Jul. 31, 2025

(30) Foreign Application Priority Data
Sep. 5, 2024 (DE) 102024208478.6

(51) Int. Cl. G06F 21/60

(52) U.S. Cl. CPC G06F 21/602

(57) ABSTRACT

Example implementations according to the present disclosure include a device for securing diagnostic data relating to the operation of a computing unit, wherein the device has an interface and a securing unit. The interface is configured to obtain the diagnostic data of the computing unit. The securing unit is formed as a hardware structure that can be operated separately from the computing unit. Furthermore, the securing unit is configured to secure the diagnostic data using session keys and to provide a change between session keys (re-keying) independently of the operation of the computing unit.

### CROSS-REFERENCE TO RELATED APPLICATION

This application claims priority to Germany Patent Application No. 102024208478.6 filed on Sep. 5, 2024, the content of which is incorporated by reference herein in its entirety.

### TECHNICAL FIELD

Example implementations according to the present disclosure include devices, methods and computer programs for securing diagnostic data.

Example implementations include in particular devices and methods for buffering or storing trace session keys.

### BACKGROUND

Modern microcontrollers have a comprehensive debug and trace subsystem for system analysis in the event of unforeseen behaviour. The former provides invasive control of the system with the ability to stop program execution, and the latter provides non-invasive insight into program execution and system internals. Today, the debug and trace subsystems are functionally separate, and therefore one can be used independently of the other. This separation allows the trace subsystem to be used even in devices where an enabled debug subsystem would be a serious security issue in security-critical applications and could also adversely affect security measures implemented in the end system.

In installed systems, the debug subsystem is either disabled, password-locked, or requires another form of authentication before it can be enabled. This does not necessarily apply to the trace subsystems. In addition, the trace data from the device are even transmitted in plain text. A typical trace subsystem does not use security functions for data transmission.

Given that a trace system can generate a large amount of data in a very short time, modern microcontrollers use the existing Ethernet MAC peripherals to transmit trace data with a high bandwidth. This can also be implemented in production devices that are integrated into an end system that runs in the field. The relevant system is connected to an internal communications network, which is then accessible from the outside via a gateway. Currently, these data are not encrypted, therefore anyone who has access to the internal network can spy on the transmitted data. This data may contain personal information, system locations, secrets, etc., where confidentiality is an essential asset.

Therefore, there is a need for an improved concept for the use of trace data, which has an improved compromise in terms of data security, complexity in terms of hardware and computational effort, and robustness of the concept.

Such a concept is provided using the subject-matter of the independent claims. Further developments according to example implementations are defined based on the dependent claims.

### SUMMARY

Example implementations according to the present disclosure include a device for securing diagnostic data relating to the operation of a computing unit, wherein the device has an interface and a securing unit. The interface is configured to obtain the diagnostic data of the computing unit. The securing unit is formed as a hardware structure that can be operated separately from the computing unit. Furthermore, the securing unit is configured to secure the diagnostic data using session keys and to provide a change between session keys (re-keying) independently of the operation of the computing unit.

In particular, the diagnostic data can include trace data (e.g., data for tracking) and/or debug data (e.g., troubleshooting data) relating to the operation of the computing unit. The diagnostic data can therefore be log data or, in particular, on-chip trace data. Diagnostic data include, for example, raw data, which allow a conclusion can be drawn about a state or a sequence of states of the computing unit, or also already processed and in particular interpreted data, based on which diagnostic information or troubleshooting information with regard to the operation of the computing unit can be derived. In the case of the diagnostic data, therefore, it can be in particular data for analysis or already analysed data with regard to the operation of the computing unit, for example in the form of monitoring data. The data may be or may have been, for example, generated automatically by the computing unit during operation. The diagnostic data can thus in particular be data that are not in themselves necessary for the operation of the computing unit. This means that the data can, for example, be a kind of meta-information, using which the operation of the computing unit can be characterized and/or evaluated.

The securing unit is configured, for example, to authenticate and/or encrypt the diagnostic data. Optionally, the securing unit can therefore be configured only to authenticate and/or encrypt the diagnostic data, for example, or to also authenticate and encrypt the diagnostic data, for example. In particular, the securing may include “authentication-only” and/or “authenticated encryption (AEAD)”operation.

Example implementations are based on the idea of securing the diagnostic data using session keys. The use of session keys enables reliable authentication and/or encryption of diagnostic data, so as to prevent unauthorized reading of diagnostic data and/or to ensure authenticity of the diagnostic data. Furthermore, it was recognised that diagnostic data, and thus in particular the transmission and evaluation of diagnostic data, is of great importance, especially in the event of an error in the computer unit. However, it has been recognized that in the event of an error, it is no longer possible to rely on the computing unit to secure the diagnostic data. Therefore, example implementations include the securing unit in the form of the hardware structure that can be operated separately from the computing unit, therefore in particular optionally also executed separately. This ensures that even in the event of an error, the diagnostic data is still reliably secured. It was also recognised that, especially in the context of diagnostic data, changing between individual session keys to secure the data is a core aspect for the secure and robust operation of the securing.

Therefore, the securing unit is configured in particular to provide the change between session keys independently of operation, that is for example, in particular, regardless of the state of the computing unit. A reliable change of session keys enables the avoidance of correlations in the secured diagnostic data, which could allow conclusions to be drawn about the diagnostic data and/or about session keys in the event of an attack. In particular, the approach in accordance with example implementations allows for the use of efficient and/or simple authentication and/or encryption mechanisms, which are based, for example, on the use of nonces (number for one-time use), for example, due to ensuring the robust and error-free change between session keys. For example, a nonce can be provided with a simple count register, wherein the simplicity of the provision does not lead to vulnerability of the securing due to the secured change between session keys.

Example implementations are based, among other things, on the use of stored diagnostic data session keys, for example in the case of trace data “buffered trace session keys.”

### BRIEF DESCRIPTION OF THE DRAWINGS

Example implementations according to the present disclosure will be explained in more detail hereinafter with reference to the accompanying figures. With regard to the schematic figures shown, it is noted that the function blocks shown are to be understood both as elements or features of the device according to the disclosure and as corresponding method steps of the method according to the disclosure, and also corresponding method steps of the method according to the disclosure can be derived therefrom. In the figures:

FIG. 1 shows a schematic view of a device for securing diagnostic data according to example implementations;

FIG. 2 shows a schematic view of a system according to example implementations;

FIG. 3 shows a schematic overview for use cases from the automotive sector with regard to a debug and/or tracing functionality according to example implementations;

FIG. 4 shows a schematic view of a microcontroller, MCU, according to example implementations;

FIG. 5 shows schematic views for securing diagnostic data according to example implementations in the form of authenticated encryption with associated data;

FIG. 6 shows schematic views of possible attacks on a securing system, which attacks can be counteracted using example implementations;

FIG. 7 shows an example of a sequence diagram for the acquisition of diagnostic data, as an example in the form of trace data, according to example implementations;

FIG. 8 shows a schematic view of an ECU system according to example implementations; and

FIG. 9 shows a schematic view of a sequence diagram for collecting trace data.

### DETAILED DESCRIPTION

Before example implementations are explained in more detail below with reference to the drawings, it is pointed out that identical, functionally identical or identically acting elements, objects and/or structures are provided with the same or similar reference signs in the various figures, and therefore the description of these elements set forth in different example implementations may be interchanged with one another or applied to one another.

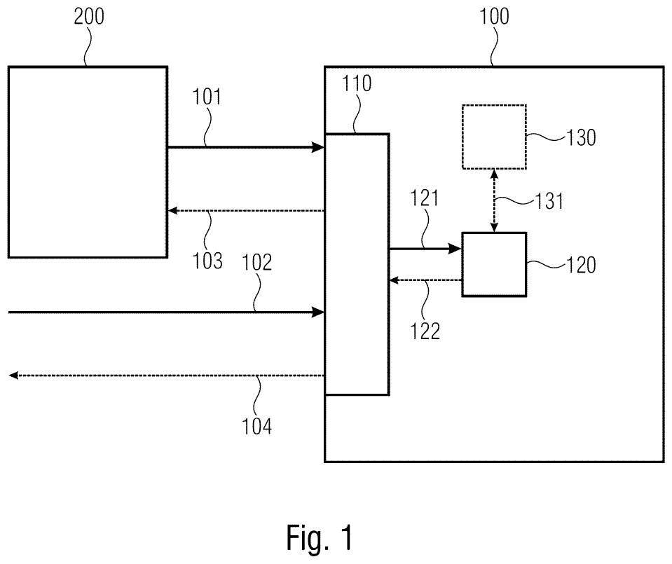

FIG. 1 shows a schematic view of a device for securing diagnostic data according to example implementations. FIG. 1 shows the device 100 for securing diagnostic data relating to the operation of a computing unit 200. The device has an interface 110 and a securing unit 120. Both the interface 110 and the securing unit 120 are comprised of hardware (e.g., include one or more hardware components). The interface 110 may be communication interface configured to receive information, data, and the like via signals.

The interface 110 is configured to obtain information 101 with respect to diagnostic data of the computing unit 200, and to pass it on to the securing unit 120 in the form of information 121 that is identical to information 101, for example, or corresponds to a processed form (e.g., decoded form) of the information 101. The information 121 can therefore be present, for example, in a form of the data 101 that is pre-processed, for example converted, by the interface 110. In addition, the information 101 and/or 121 may be directly the diagnostic data.

The securing unit 120 is formed as a hardware structure that can be operated separately from the computing unit 200. Furthermore, the securing unit 120 is configured to secure the diagnostic data using session keys and to provide a change between session keys independently of the operation of the computing unit 200. The hardware structure may include one or more processors and/or processing components.

As explained above, the diagnostic data of the information 101 and 121 may, for example, be trace data and/or debug data relating to the operation of the computing unit 200. The securing of these data using the securing unit comprises, for example, an authentication, an encryption or an authentication and an encryption.

At this point it should be noted that, in FIG. 1, further optional features, which will be explained hereinafter, are shown in dashed lines.

Optionally, the securing unit 120 is configured to provide the session keys pre-calculated independently of the operation of the computing unit 200 in advance, e.g., in the form of an OTP approach (OTP=One-Time Pad), or to calculate them. In other words, the securing unit 120 can be configured, for example, not only to perform a change of the session keys to secure the diagnostic data, but also to determine the session keys themselves. Thus, for example, the calculation of the session keys and the securing of the diagnostic data can be carried out independently of the state of the computing unit, for example in particular regardless of whether the computing unit is in an error state or not. In particular, this allows for robust securing of the diagnostic data.

In such an optional configuration, the securing unit 120 may also be configured, for example, to calculate the session keys while the diagnostic data are being generated. The calculation can be carried out, for example, using a key derivation function (KDF). Thus, the session keys can be calculated robustly and error-free, for example, during the running operation of the computing unit 200.

If a calculation of the keys is too time-intensive or resource-intensive, session keys may also be stored, secured, in advance in a pre-calculated form in a non-volatile memory. This can be done, for example, during the development phase in the laboratory or during production.

As an optional feature, the device 100 in the example of FIG. 1 additionally has a memory 130. The memory 130 may be configured to store the session keys, e.g., exchanged using information 131, for the securing of the diagnostic data. Furthermore, the securing unit 120 may in this case be configured to read out the session keys independently of the operation of the computing unit 200 from the memory 130. Accordingly, the interface 110 may be configured, for example, to obtain the session keys prior to generating the diagnostic data or, for example, prior to securing the diagnostic data, for example using information 102 and forwarding using information 121, and to make them available for the memory 130 in order to store them.

The securing unit 120 can thus, for example, retrieve information 131 comprising session keys from the memory 130. In an optional configuration, the securing unit 120 may be configured, for example, to store session keys calculated by the securing unit 120, for example for later use, in the memory 130. The use of the memory 130 allows for an efficient provision of session keys, for example in particular independently of a time-based generation of the session keys and, for example, also regardless of whether the session keys are provided by the device 100 itself or by an external unit, for example, even by the computing unit 200, for example before the diagnostic data are generated.

Optionally, the securing unit 120 may thus be configured in particular to calculate the session keys before a start of generation of the diagnostic data to be secured, relating to the operation of the computing unit 200, and to store them in the memory 130.

As a further optional feature, the interface 110 may be configured, for example, to obtain additional information from the computing unit 200, for example as part of the information 101 or to obtain additional information from an external unit, for example as part of optional information 102. The additional information may include, for example, information about a duration and/or a data volume of the diagnostic data. Optionally, the securing unit 120 is configured to determine or calculate the session keys based on such additional information, for example in particular information about the duration and/or a data amount of the diagnostic data. For example, such information can be used to specify a number of session keys to be calculated.

In this regard, example implementations optionally include securing using incrementally generated nonces. In other words, the securing unit 120 is optionally configured to encrypt the diagnostic data using incrementally generated values of a limited number range, wherein the values, for example, serve as nonces for encryption. In this case, the securing unit 120 is then optionally configured to perform a change between session keys before or when the incrementally generated values reach an end of the limited number range or would exceed the end of the limited number range using the incrementation.

For example, if the securing comprises the use of a nonce generated using cyclic incrementation, then, for example, a duration and/or data amount of the diagnostic data can be used to determine how often the incrementation of the nonces leads to an overflow, and therefore the key must be changed in order to avoid double use of a nonce key pair. Moreover, corresponding additional information may also contain at least one from information relating to a start of a recording of the diagnostic data, a configuration of the diagnostic data, a content of the diagnostic data and/or a type of diagnostic data. Such information, for example 102, can be provided by a debug interface, for example. This can be in particular a debug host system interface, which provides such additional information. The debug interface can therefore be used to determine in particular what is “written out”.

As a further optional feature, the interface 110 may be configured to provide the computing unit 100 with a signal 103 for a start of a recording of the diagnostic data.

Hereinafter, example implementations are discussed, among other things, in the context of their embedding in systems according to the disclosure. Further optional functionalities and details of implementations are also explained. In other words, a device according to FIG. 1 may, for example, be part of one of the systems explained below and/or have one or more of the functionalities explained below. The following explanations focus in particular on diagnostic data in the form of debug and/or tracing data (also referred to herein as trace data), but are not limited to one or other data form. This means that, for example, corresponding functionalities, which are explained in the context of trace data, must be understood equally or correspondingly also with regard to debug data. The same applies conversely to explanations regarding functionalities with regard to debug data for functionalities with regard to trace data.

The same applies to securing, which can include authentication and/or encryption as previously explained. This means that device features, which are discussed, for example, in the context of encryption, are to be understood, for example, equally with regard to the functionality of securing, e.g., generally any combination of authentication and encryption.

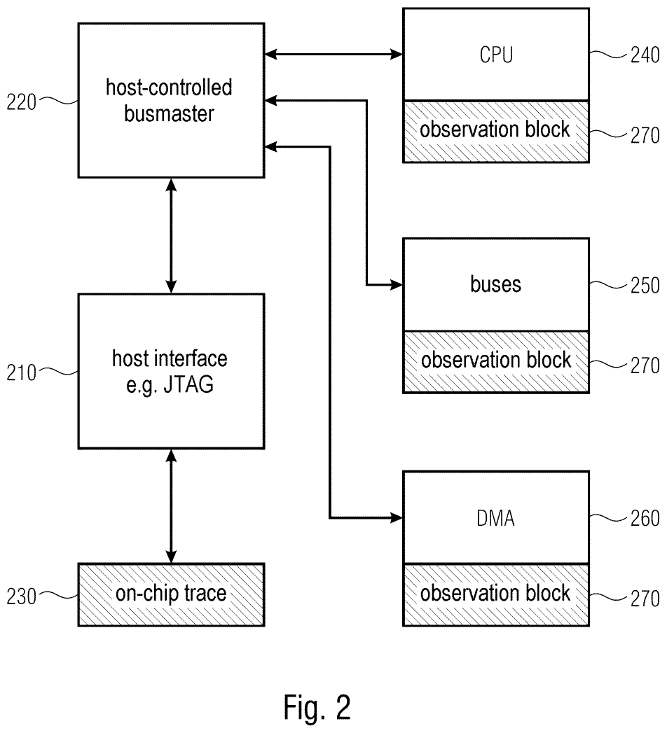

FIG. 2 shows a schematic view of a system according to example implementations, in which system a device according to FIG. 1 can be embedded, for example. Such a system comprises, as an example, a host interface 210, for example JTAG, a host-controlled busmaster 220, an on-chip trace 230, a CPU 240, busses 250 and a direct memory access (DMA) 260. CPU 240, buses 250 and DMA 260 include observation blocks 270, for example.

Referring to FIG. 2, the basics of debug and tracing functionalities in accordance with example implementations are explained hereinafter: Debugging describes invasive control and monitoring of system resources, for example. Tracing describes non-invasive monitoring of system resources, for example, without affecting program execution, for example.

Main components for such a system, for example a debug and/or tracing system, are the above-described of FIG. 2 for example, namely the three main components:
Host-system interface 210, for example in the form of a debug interface, such as JTAG (Joint Test Action Group), SWD (Single Wire Debug from ARM) or DAP (Debug Access Port from Infineon),
Host controlled access method, such as Cerberus(CBS) or DAP-AP (Debug Access Port from ARM) and
one or more observation blocks 270, such as OCDS (On-Chip Debug Support).

In addition, reference is made to the on-chip trace 230 at this point.

A key feature, at least of some example implementations, for example for modern microcontrollers in the automotive sector, is for example a comprehensive debug and trace subsystem that is functionally separated in order to enable independent use. A corresponding trace subsystem can therefore be used, for example, in a used device, even in safety-critical applications.

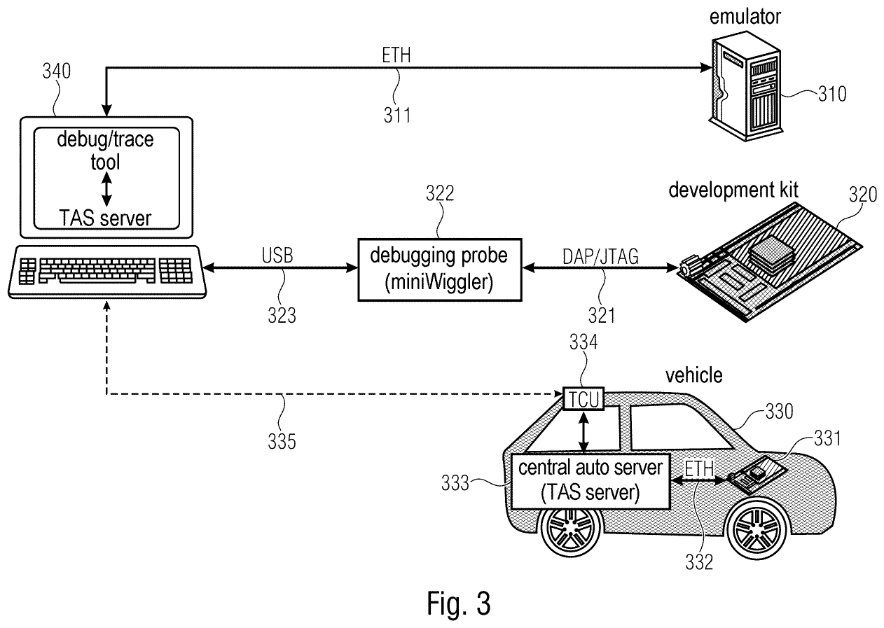

FIG. 3 shows a schematic overview for use cases from the automotive sector with regard to a debug and/or tracing functionality according to example implementations. In this regard, FIG. 3 shows, as an example, debug and/or tracing processes in different development phases of software and/or hardware. Early software development (e.g., Pre-Silicon) can be carried out, for example, using a microcontroller (e.g., AURIX®) emulator (e.g., ZeBu or Virtualizer from Synopsys) 310.

For example, a subsequent standard software development can be carried out with evaluation and development kits 320 using a test bench.

In field use, of a corresponding vehicle 330 for example, diagnostic processes (e.g., Remote Vehicle Diagnosis) can then be performed remotely or even exclusively remotely in a subsequent development phase, for example.

For debugging and/or tracing, for example, the debug/trace tool 340, which can optionally have a tool access service, TAS, interface or a corresponding server, can carry out here. Communication with a corresponding emulator 310 can be provided, for example, using an Ethernet connection 311.

With regard to debugging and/or tracing for a corresponding development kit 320, an exchange of information with a debugging probe 322 using a debug access port and/or a JTAG (Joint Test Action Group) 321 and a USB connection 323 can furthermore be implemented, as shown as optional features in FIG. 3.

In a corresponding vehicle 330, for example as a final product, a corresponding hardware component 331, for example corresponding to the development kit 320, can in turn be permanently installed and connected via an Ethernet connection 332 to a central server 333, in order to provide corresponding data using a TCU 334 (TCU=Telematic Control Unit) via a wireless connection 335.

Example implementations, for example in an implementation according to FIG. 1 (with or without the optional features shown in FIG. 1), allow the use of the same software infrastructure for diagnostic applications from early development phases (see e.g., emulator 310) up to wireless monitoring or wireless diagnostics in the final product, such as vehicle 330 here, e.g., also in field use. Example implementations thus also allow access to and/or use of software originating from suppliers and/or original equipment manufacturer software for prototypes. In other words, for example, software from different manufacturers can be used on the same device.

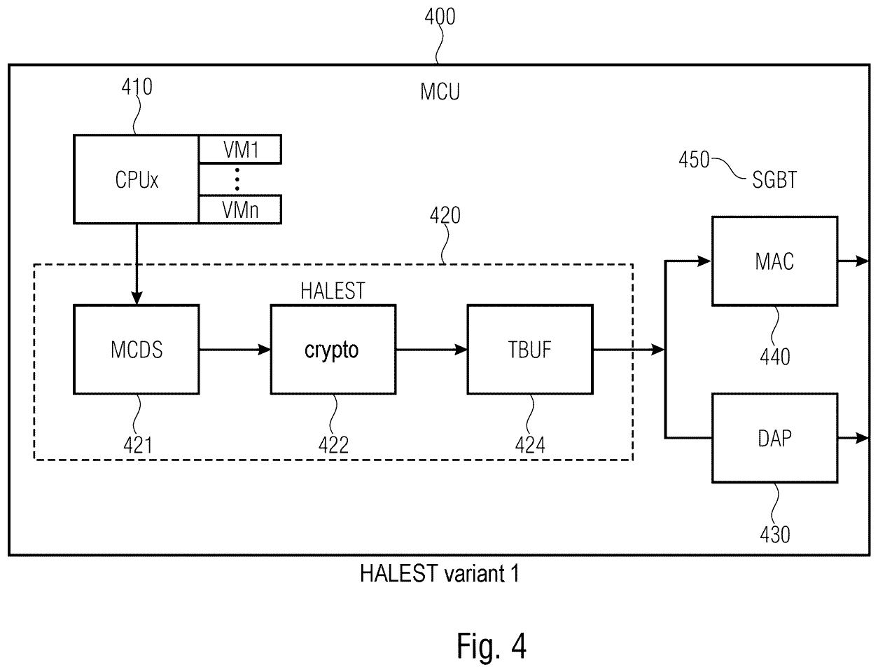

Reference is made to FIG. 4. FIG. 4 shows a schematic view of a microcontroller, MCU, according to example implementations. Microcontroller 400 comprises a CPU 410 (e.g., with virtual cores VM), as well as a unit 420 (e.g., a tracing unit, e.g., for Highest Active Labeled Event System Trace) comprising a multi-core debug solution unit 421, a securing unit (crypto) 422, here as an example an encryption unit, and a memory (TBUF) 424. Furthermore, the microcontroller 400 comprises a debug access port 430 and a media access control 440. As another optional feature, the MCU includes a standard interface, such as an SGBT unit 450.

Referring to FIG. 4, the problem of a trace subsystem in accordance with example implementations will be explained in more detail below. A trace subsystem can generate a large amount of trace data in a very short period of time. For example, such data can be forwarded from the CPU 410 to the MCDS (Multi-Core Debug Solution) 421. To output the data (e.g., in the form of a data stream), an existing Ethernet MAC 440 can be used according to example implementations. In order to secure the trace data, encryption methods can be used, which usually require a nonce. For example, such a nonce can be a time stamp of a trace message.

However, there is a risk that such a time stamp is part of the same set of trace data due to the nature of the time stamp creation (e.g., using a cyclical counter) and trace data generation based on the configuration of the trace subsystem and the program flow.

Accordingly, without a corresponding securing unit according to example implementations, there would be a certain probability that the same key-nonce pair is used to secure the same data.

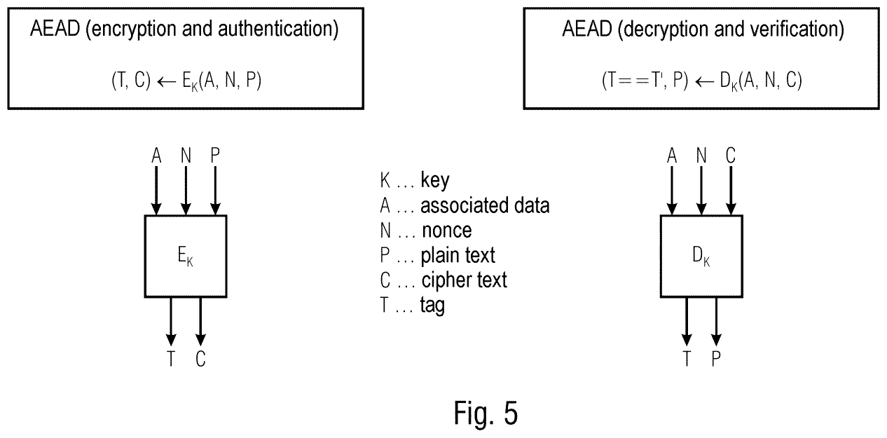

This problem will be explained in detail below with reference to FIG. 5. FIG. 5 shows schematic views for a securing of diagnostic data according to example implementations in the form of authenticated encryption with associated data (AEAD); FIG. 5 shows in particular the parameters used for this purpose. FIG. 5, on the left, shows a schematic view of an encryption and authentication according to example implementations. A function Ek, which receives associated data A, a nonce N and the diagnostic data to be secured, in this case plain text P, provides a result in the form of secured diagnostic data, here cipher text C, and a tag T. FIG. 5, on the right, shows the case of decryption and verification. The diagnostic data P and a tag T′ are determined using a function DK based on the associated data A, nonce N and secured diagnostic data C. Authentication can be provided by comparing the tag T with the determined tag T′.

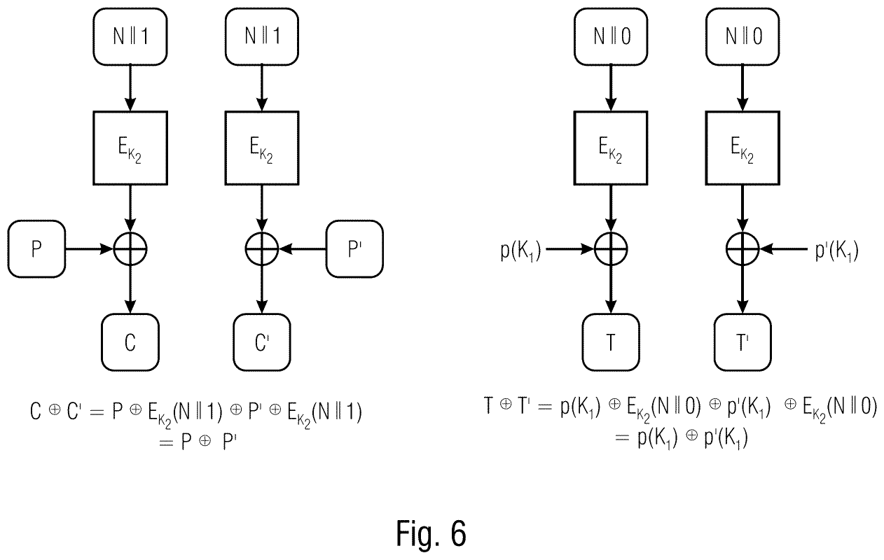

The problem of multiple use of a nonce or a nonce key pair is explained in more detail below with reference to FIG. 6. It should be noted that the AES-GCM (Advanced Encryption Standard-Galois/Counter Mode) algorithm, for example, can be used to secure and in particular to authenticate and encrypt diagnostic data.

Attacks discussed below refer in particular (but not exclusively) to such an implementation. FIG. 6, on the left-hand side, shows a schematic view of an attack in which the diagnostic data themselves, e.g., the plain text, are recovered. To do this, for example, an attacker may have obtained two different sets of secured diagnostic data, here as an example cipher texts C and C′, which were generated, however, with the same nonce N and the same secret key K₂. The attacker can destroy confidentiality by restoring the underlying plain text. This is possible due to the deletion property of the XOR operation.

FIG. 6, on the right, shows a schematic view of an attack to obtain the key. To do this, for example, an attacker may have obtained two different MAC tags T and T′, which were generated with the same nonce N and the same secret key K₂. The attacker can destroy the authenticity or integrity by determining the hash key K₁ and then providing a message (e.g., Joux Forbidden attack) itself using the key.

With regard to FIGS. 5 and 6, it is therefore again summarized that assuming that the diagnostic data, in particular trace data, are secured, the cryptography may normally require a nonce (number used once), which can be, for example, the time stamp of a corresponding trace message. However, this time stamp may be part of the same trace data due to the nature of the time stamp and the corresponding trace data, which are generated based on the configuration of the trace subsystem and of the program sequence. Therefore, without the use of example implementations, there would be a certain probability that the same key and the same nonce would be used to secure the same data.

For this purpose, a device according to example implementations, for example a device as shown in FIG. 1, may be configured to provide a key determination function. In this case, the securing unit 120 may be configured, for example, as a hardware block in order to provide a corresponding key derivation function, KDF.

Such example implementations can therefore be based in particular on the idea of a key provision function, KDF, in the form of such a small hardware block additionally or as part of a MACsec hardware IP (e.g., MACsec IP), e.g., in Ethernet MAC. The hardware block can optionally calculate session keys, SK, for example in particular trace session keys, optionally at runtime.

Optionally, however, according to example implementations, a set of pre-calculated session keys can also be provided, e.g., pre-calculated by the hardware block or by an external unit or the computing unit to be traced, for storage in the hardware block.

For example, the calculation can be carried out using one or more predefined trigger points. With the set of pre-calculated session keys, a corresponding trace system according to example implementations can be implemented as a non-invasive system, which is an important aspect of any trace system.

In other words, example examples make it possible to provide a set of pre-calculated session keys. As explained above, the session keys can be pre-calculated and stored either internally, for example using the device 100 itself, or be provided as a result of a calculation of an external unit of the interface 110 in order to be stored in an optional memory 130. However, as already explained, example implementations also make it possible, for example as an alternative to a pre-calculation of session keys, to calculate session keys during the generation of diagnostic data. For example, new session keys can also be calculated at the beginning of a new trace session using the KDF. One advantage of this is, for example, that the acquisition of trace data remains non-invasive.

A number of corresponding session keys may, for example, be predetermined or determined in advance based on information regarding a trace duration and/or an amount of tracing data, for example based on information regarding a configuration, e.g., tracing configuration, for the generation of the diagnostic data. As an optional feature, the KDF can be based on a previously exchanged key, for example a long-term key (LTK).

The long-term key may have been established in particular beforehand between the two end points tracer (unit that carries out trace/debug) and tracee (unit that is traced/debugged).

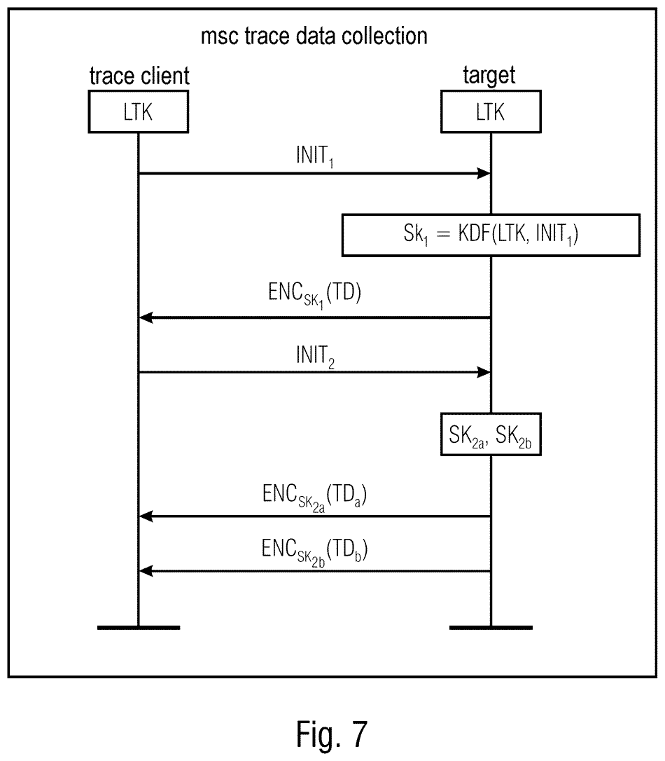

Hereinafter, reference is made to FIG. 7. FIG. 7 shows an example of a sequence diagram for the acquisition of diagnostic data, as an example in the form of trace data, according to example implementations. As shown in FIG. 7, for example, a trace client and a trace target may have a previously exchanged long-term key, LTK. For example, the trace client can request INIT 1 trace data from the target with a message. A corresponding start signal for the beginning of a recording of trace data can be provided, for example, in particular by an interface 110, as shown in FIG. 1. The INIT₁ signal can include information about the configuration of the trace data, based on which, for example, a required number of session keys can be specified in order to ensure secure securing of the trace data. In the example of FIG. 7, for example, a session key SK₁ based on the previously discussed KDF, can be determined based on the INIT₁ signal. In this case, for example, a single key may suffice to secure the requested set of trace data. Accordingly, an interface 110, as shown in FIG. 1, may be configured, for example, to output the secured diagnostic data (see, for example, 104, 122). The interface 110 can therefore have an Ethernet interface in particular. In the example of FIG. 7, the diagnostic data, which for example may also include debug data, are shown as trace data, TD, and the corresponding secured output is denoted by ENC_{SK1} (TD).

FIG. 7 also shows a second request for diagnostic data in the form of the INIT₂ signal. As shown, it can be inferred based on configuration information contained in INIT₂, for example, that due to an overflow of the nonces, a single key is not sufficient to secure the data, and therefore the generation of two keys SK₂ₐ and SK_{2b} is shown here.

As already explained in the context of FIG. 1, example implementations allow for a key change independently of the operation of the computing unit, for example the diagnostic-data-generating target.

Thus, according to some example implementations, secure diagnostic data, especially trace data, can be attained or provided by using a hardware implementation instead of a software-based implementation. As explained earlier, the hardware implementation can relate, for example, at least to the key change, but also to the provision or calculation of the keys. In particular, the provision of secure trace data can be achieved by using a hardware implementation based on a MACsec, e.g., instead of a software-based implementation based on TLS (Transport Layer Security) and TCP (Transmission Control Protocol) or DTLS (Datagram Transport Layer Security) and User Datagram Protocol (UDP). Thus, example implementations allow for a non-invasive acquisition of diagnostic data, for example trace data in particular, even when security mechanisms are enabled.

As also explained previously, due to or in view of the amount of possible generated diagnostic data, it may be necessary to provide key changes (for example, to perform re-keying) in order to avoid nonce collision, if a separate session key, SK, is used or would be used. According to example implementations, for example, if an internal time stamp of a diagnostic message, such as a trace message, is used as a nonce, a new session key can be used, generated and/or calculated with each overrun of the time-stamp timer. Here it should be pointed out once again that, in addition to a recalculation of a new key due to such an overrun, a change based on a previously stored amount of keys is also possible, for example using a memory 130, as shown in FIG. 1. As explained earlier, some example implementations are based on a previously exchanged long-term key between a trace client and a target.

According to example implementations, the determination of a new session key, which is based, for example, on the key determination function set out below, for example using a one-step (e.g., so that, for example, a key is derived directly from an output value or key, e.g., LTK, without additional intermediate stages or transformations) or even two-step (e.g., 1st VAR=f1(LTK, “Config”) and then 2nd SK=f2(VAR, “Config2”)) key determination function as defined, for example, in NIST SP 800-56C Rev. 2 (E. Barker, L. Chen, and R. Davis, “Recommendation for Key-Derivation Methods in Key-Establishment Schemes,” National Institute of Standards, Aug. 2020. DOI: 10.6028/NIST. SP.800-56Cr2 (p. 5, 19-24)), which is incorporated by reference herein:

SK=KDF(Z, OtherInput), wherein
Z: a byte string representing the common secret (in this case e.g., LTK);
OtherInput (other inputs): salt, L, FixedInfo (fixed information), wherein salt: A non-null byte string (secret or non-secret). For example, a value calculated from a nonce,
   L: Length (in bits) indicating the length of the derived key material,
   FixedInfo: A bit sequence of context-specific data

With regard to the previous explanation, at this juncture it should be pointed out again that, for example, a securing unit 120 is optionally configured to encrypt the diagnostic data using incrementally generated values of a limited number range. In this case, the securing unit 120 is then optionally configured to perform a change between session keys before or when the incrementally generated values reach an end of the limited number range or would exceed the end of the limited number range using the incrementation. Accordingly, the incrementally generated values can serve as nonces for the securing. As previously explained, time stamps of the diagnostic data can also be used for this purpose. Thus, by changing the key, before an overflow, for example an arithmetic overflow occurs, multiple use of a nonce key pair can be avoided.

In summary, FIG. 7 therefore shows, for example, a predetermined example implementation in which a trace client configures the trace subsystem of a target and triggers the start of a tracing session. For example, the target can accordingly generate one or more session keys (or for example optionally obtain them from a memory, e.g., 130) in order to secure the trace data, e.g., to encrypt it, for example. A key change, for example the use of a new session key, can be carried out whenever the internal time stamp timer reaches an overrun, e.g., the timer overruns, for example, see FIG. 7.

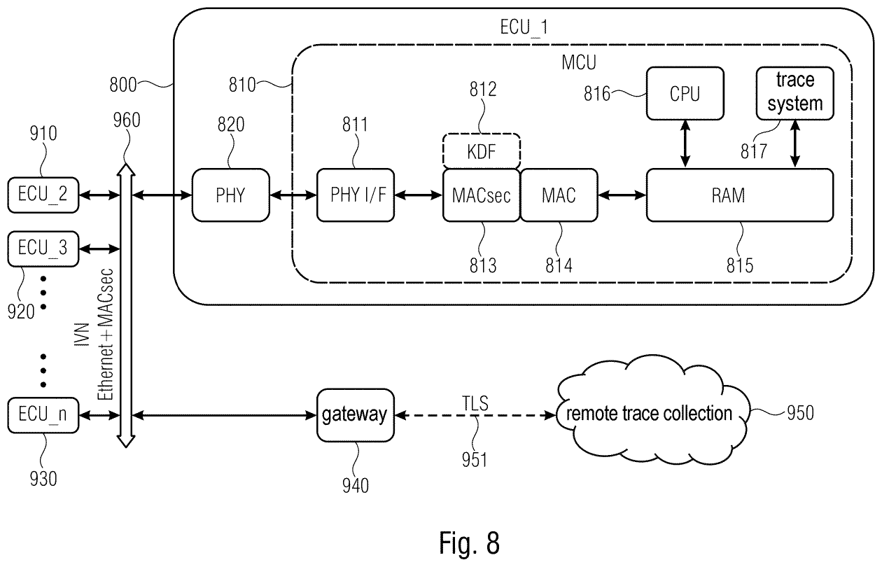

Reference is made to FIG. 8. FIG. 8 shows a schematic view of an ECU system according to example implementations. In particular, FIG. 8 shows an example of a trace data flow using MACsec and KDF. FIG. 8 shows an electronic control unit 800 comprising a microcontroller, MCU, 810 and a physical layer transceiver 820. Microcontroller 810 further comprises an interface 811, a MACsec hardware block 813, a key derivation function hardware block 812, a MAC 814, RAM (Remote Access Memory) 815, a CPU (Central Processing Unit) 816 and a trace system 817. The system also comprises a network 960, as an example an in-vehicle network (e.g., an internal vehicle network), INV, which provides a connection to further electronic control units 910, 920 and 930. Furthermore, the system comprises a gateway 940, which is in communication with a remote trace acquisition 950 using TLS 951.

In particular, according to example implementations, a corresponding interface, e.g., 110 from FIG. 1, for example corresponding to 811, can be configured as an Ethernet interface, or have such an interface.

In other words, FIG. 8 shows an example ECU application (here with several ECUs) in which an on-chip trace can be used for remote diagnostics, according to an exempalry implementation.

Hardware block 812 can correspond, for example, to the securing unit 120 from FIG. 1. For example, the interface 110 can be part of the block 813. In other words, the device, for example device 100 from FIG. 1, can be part of a media access control security hardware architecture. Optionally, a part of the interface 110 can also be formed by the interface 811. Alternatively, however, the device or at least the securing unit may also be formed as a hardware structure that can be operated separately from the media access control security hardware architecture. The trace system 817 corresponds, for example, to the computing unit 200 from FIG. 1. As shown optionally, for example, the device and the computing unit can be implemented on a common system on-chip, e.g., 810. In particular, the common system on-chip can be part of an electronic control unit 800, that is, in particular, an ECU, electronic control unit.

In the configuration shown in FIG. 8, the device according to example implementations is further implemented as an optional feature on a common system on chip (SoC, here MCU), 810, with the computing unit 817.

With regard to FIG. 8, it should be pointed out once again that a device according to example implementations, e.g., as discussed in FIG. 1, is not restricted to a single implementation. Thus, parts of the interface 110 can be formed based on element 811, e.g., for the information 102 and/or 104, whereas part of the interface 110 for the information 101 and/or 103 may be part of the block 814. In other words, further elements may also be arranged between device 100 and computing unit 200.

In other words, FIG. 8 shows an example application in which a corresponding mechanism according to example implementations for session keys is advantageous or even necessary, namely the field of application of an electronic control unit, ECU, for a vehicle. Example implementations may have advantages in particular in this case or may even be necessary if on-chip trace data are used as part of remote diagnostic data, in other words for remote diagnostic applications, e.g., wireless diagnostic applications. The on-chip trace subsystem, for example unit 812, can be used to generate diagnostic data, for example program data and/or trace data of a target application. These data can then be transmitted via an Ethernet MAC, see FIG. 8.

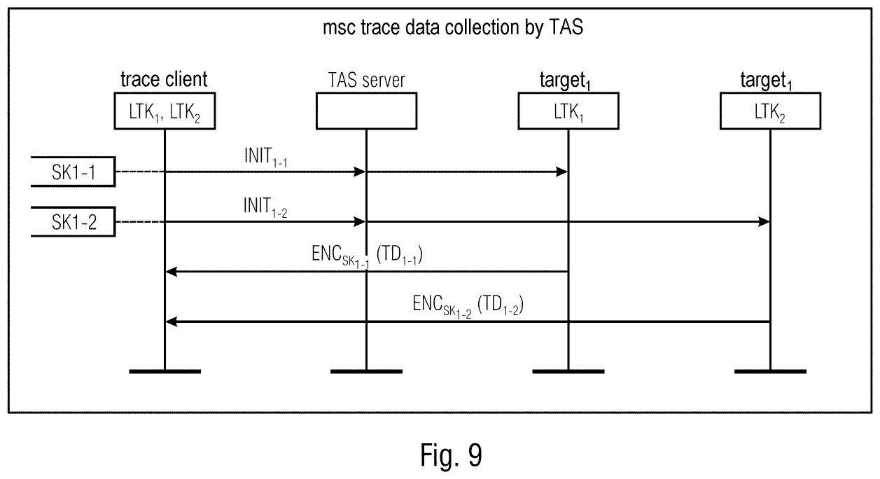

As shown in FIG. 8, for example, a debug host management server in a central unit (for example, gateway 940) can be used for the purpose of trace data acquisition, which server is capable of communicating with the target device, for example 817. A trace client requests an acquisition of trace data, for example, and the request is then forwarded, for example, by the debug host management server to the corresponding target, which is identified with the request based on corresponding information. Generated trace data are then transmitted, for example, from the corresponding device to the corresponding trace client. An assignment, for example mapping, can take place within the debug host management server, for example. For this purpose, reference is also made to FIG. 9.

In this regard, FIG. 9 shows a schematic view of a sequence diagram for collecting trace data using the debug host management server according to example implementations. In a simplified form, LTK1=LTK2, for example, can be taken into account. Thus, diagnostic data can be provided and communicated for a multiplicity of computing units.

As explained above, example implementations can be used in particular in the vehicle sector. With many autonomous functions in current and future vehicles, the need for improved software observability of the devices used is growing. Therefore, secured diagnostic data in accordance with example implementations are advantageous for many applications, or even necessary to prevent the disclosure of proprietary information, personal data, cryptographic keys, and other device data.

In summary, example implementations can thus be used in all areas of cyber security in the automotive industry, Internet-of-Things applications and in particular for microcontrollers and microprocessors.

Example implementations are summarized below:

Example implementations and aspects of the disclosure that may be used individually or in combination with any of the features, functionalities and details described herein are described below.

### ASPECTS

A first aspect relates to a device for securing diagnostic data, e.g., log data, e.g., on-chip trace data relating to the operation of a computing unit (e.g., data for the analysis and/or monitoring of the computing unit, e.g., data which are automatically generated during operation by the computing unit), wherein the device has the following features: an interface which is configured to obtain the diagnostic data of the computing unit; a securing unit, which is formed as a hardware structure that can be operated separately from the computing unit, and which is configured to secure the diagnostic data using session keys, and to provide a change between session keys, for example re-keying, independently of the operation, e.g., regardless of a state, of the computing unit.

According to a second aspect with reference to the first aspect, the diagnostic data include trace data and/or debug data relating to the operation of the computing unit.

According to a third aspect with reference to the first or second aspect, the securing unit is configured to authenticate and/or encrypt the diagnostic data.

According to a fourth aspect with reference to one of the aspects one to three, the securing unit is configured to calculate the session keys independently of the operation of the computing unit, so that, for example, the calculation of the session keys and the securing of the diagnostic data are made possible regardless of a state of the computing unit, e.g., regardless of whether the computing unit is in an error state or not.

According to a fifth aspect with reference to the fourth aspect, the securing unit is configured to calculate the session keys during generation of the diagnostic data, for example using a key derivation function, KDF, which is configured to use the session keys e.g., during operation of the computing unit.

According to a sixth aspect with reference to one of the aspects one to five, the device has a memory that is configured to store the session keys for securing the diagnostic data, and the securing unit is configured to read out the session keys from the memory independently of the operation of the computing unit, wherein the device is configured to obtain the session keys before generation and/or before the start of the securing of the diagnostic data, for example using the interface, and to store them in the memory.

According to a seventh aspect with reference to the sixth aspect, the securing unit is configured to calculate the session keys before the start of generation of the diagnostic data to be secured and to store them in the memory.

According to an eighth aspect with reference to one of the aspects one to seven, the securing unit is configured to secure, for example to encrypt, the diagnostic data using incrementally generated values of a limited number range, wherein the values are used as nonces, for example, for the encryption, and the securing unit is configured to perform a change between session keys before or when the incrementally generated values reach an end of the limited number range or would exceed the end of the limited number range using the incrementation, e.g., when or before an overflow, e.g., an arithmetic overflow, occurs or would occur; e.g., to avoid multiple uses of a nonce with the same key.

According to a ninth aspect with reference to the seventh aspect, the values are nonces in the form of time stamps of the diagnostic data.

According to a tenth aspect with reference to one of the aspects one to nine, the device is part of a media access control security hardware architecture, e.g., IEEE802.1AE MACsec.

According to an eleventh aspect with reference to one of the aspects one to ten, the device or at least the securing unit is formed as a hardware structure that can be operated separately from a media access control security hardware architecture, which hardware structure serves the predefined interfaces (APIs) of the IEEE802.1AE MACsec hardware.

According to a twelfth aspect with reference to one of the aspects one to eleven, the interface is configured to obtain information about a duration and/or a data amount of the diagnostic data, and the securing unit is configured to determine the session keys based on the information about the duration and/or data amount of the diagnostic data, e.g., in particular a number of session keys.

According to a thirteenth aspect with reference to one of the aspects one to twelve, the securing unit is configured to determine the session keys based on a long-term key.

According to a fourteenth aspect with reference to one of the aspects one to thirteen, the securing unit is configured to determine the session keys based on the key determination method in accordance with E. Barker, L. Chen, and R. Davis, “Recommendation for Key-Derivation Methods in Key-Establishment Schemes,” National Institute of Standards, techreport, Aug. 2020. DOI: 10.6028/NIST. SP.800-56Cr2, which is incorporated by reference herein (e.g., in accordance with the National Institute of Standards and Technology (NIST)).

According to a fifteenth aspect with reference to one of the aspects one to fourteen, the device and the computing unit are implemented on a common system on chip.

According to a sixteenth aspect with reference to one of the aspects one to fifteen, the common system on chip is part of an electronic control unit, e.g., ECU =Electronic Control Unit.

According to a seventeenth aspect with reference to one of the aspects one to sixteen, the interface has an Ethernet interface to output the secured diagnostic data.

According to an eighteenth aspect with reference to one of the aspects one to seventeen, the interface is configured to provide the computing unit with a signal for the start of recording of the trace data.

According to a nineteenth aspect with reference to aspect eighteen, the interface is configured to obtain, from a debug interface, for example a debug host system interface, information relating to the start of the recording of the diagnostic data; a configuration of the diagnostic data; a content of the diagnostic data; and/or a type of diagnostic data.

A twentieth aspect relates to a method for securing diagnostic data relating to the operation of a computing unit, wherein the method has the following steps: obtaining the diagnostic data of the computing unit using an interface; securing the diagnostic data using session keys and providing a change between session keys, independently of the operation of the computing unit, using a securing unit that is formed as a hardware structure that can be operated separately from the computing unit.

A twenty-first aspect relates to a computer program with a program code for performing the method according to the twentieth aspect, if the program runs on a computer.

A further aspect relates to a non-transitory computer-readable medium comprising a computer program having a program code for causing a computer system to perform a method for securing diagnostic data relating to an operation of a computing unit, the method comprising: obtaining the diagnostic data of the computing unit using an interface; and securing the diagnostic data using session keys and providing a change between the session keys, independently of the operation of the computing unit, using a securing unit that is formed as a hardware structure that is operated separately from the computing unit.

A further aspect relates to a non-transitory computer-readable medium having computer-readable instructions stored thereon which when executed by a computer system cause the computer system to perform a method for securing diagnostic data relating to an operation of a computing unit, the method comprising: obtaining the diagnostic data of the computing unit using an interface; and securing the diagnostic data using session keys and providing a change between the session keys, independently of the operation of the computing unit, using a securing unit that is formed as a hardware structure that is operated separately from the computing unit.

The acronyms used are summarized below:

KDF: Key Derivation Function, LTK: Long Term Key, MAC: Media Access Control, SK: Session Key, ECU: Electronic Control Unit, TCP: Transmission Control Protocol, TLS: Transport Layer Security, UDP: User Datagram Protocol, DTLS: Datagram Transport Layer Security.

All lists of materials, environmental influences, electrical properties and optical properties listed herein are to be regarded as examples and not as being exhaustive.

Although some aspects have been described in connection with a device, it is to be understood that these aspects also constitute a description of the corresponding method, with the result that a block or a structural element of a device should also be understood to be a corresponding method step or a feature of a method step. Analogously thereto, aspects which have been described in connection with a method step or as a method step also constitute a description of a corresponding block or detail or feature of a corresponding device. Some or all of the method steps can be performed by a hardware apparatus (or using a hardware apparatus), such as a microprocessor, a programmable computer or an electronic circuit. In some example implementations, some or more of the most important method steps can be performed by such an apparatus.

Depending on certain implementation requirements, example implementations may be implemented in hardware or in software. The implementation can be performed using a digital storage medium, for example a floppy disk, a DVD, a Blu-ray disc, a CD, a ROM, a PROM, an EPROM, an EEPROM or a FLASH memory, a hard disk or another magnetic or optical memory, on which electronically readable control signals are stored that can interact or do interact with a programmable computer system such that the respective method is performed. For this reason, the digital storage medium can be computer-readable.

Some example implementations thus comprise a data carrier that has electronically readable control signals, which are capable of interacting with a programmable computer system in such a way that one of the methods described here is performed.

In general, example implementations can be implemented as a computer program product having a program code, wherein the program code acts to perform a method if the computer program product is executed on a computer.

The program code can also be stored, for example, on a machine-readable carrier.

Other example implementations comprise the computer program for performing one of the methods described here, wherein the computer program is stored on a machine-readable carrier.

In other words, an example implementation is thus a computer program that has a program code for performing one of the methods described herein, if the computer program runs on a computer.

A further example implementation is thus a data carrier (or a digital storage medium or a computer-readable medium), on which the computer program for performing one of the methods described herein is recorded. The data carrier, the digital storage medium or the computer-readable medium are typically tangible and/or non-volatile or non-transitory.

A further example implementation is thus a data stream or a sequence of signals, which represents or represent the computer program for performing one of the methods described herein. The data stream or the sequence of signals can be configured, for example, so as to be transferred via a data communication connection, for example the Internet.

A further example implementation comprises a processing device, for example a computer or a programmable logic device, which is configured or adapted for performing one of the methods described herein.

A further example implementation comprises a computer on which the computer program for performing one of the methods described herein is installed.

A further example implementation comprises an apparatus or system, which is configured to transmit a computer program for performing at least one of the methods described herein to a receiver. The transmission can be electronic or optical, for example. The receiver can be, for example, a computer, a mobile device, a storage device or a similar apparatus. The apparatus or the system can comprise, for example, a file server for transmitting the computer program to the receiver.

In some example implementations, a programmable logic device (for example a field programmable gate array, FPGA) can be used to perform some or all functions of the methods described here. In some example implementations, a field programmable gate array can act together with a microprocessor to perform one of the methods described herein. In general, the methods in some example implementations are performed by any desired hardware apparatus. The latter can be universally usable hardware, such as a computer processor (CPU) or hardware that is specific to the method, such as an ASIC.

The devices described herein may be implemented, for example, using a hardware apparatus, or using a computer, or using a combination of a hardware apparatus and a computer.

The devices described herein, or any components of the devices described herein, may be implemented at least partially in hardware and/or in software (computer program).

The methods described herein may be implemented, for example, using a hardware apparatus, or using a computer, or using a combination of a hardware apparatus and a computer.

The methods described herein, or any features of the methods described herein, may be implemented at least partially by hardware and/or by software (computer program).

The above-described example implementations are merely an illustration of the principles underlying the present implementation. It is to be understood that modifications and variations of the arrangements and details described herein will be obvious to others skilled in the art. For this reason, it is intended that the scope of protection should not be limited by the specific details which have been presented herein based on the description and the explanation of the example implementations.

1. A device for securing diagnostic data relating to an operation of a computing unit wherein the device comprises:
an interface configured to obtain the diagnostic data of the computing unit; and
a securing unit which is formed as a hardware structure that can be operated separately from the computing unit, and which is configured to secure the diagnostic data using session keys and to provide a change between session keys independently of the operation of the computing unit.

2. The device according to claim 1, wherein the diagnostic data include trace data and/or debug data relating to the operation of the computing unit.

3. The device according to claim 1, wherein the securing unit is configured to authenticate and/or encrypt the diagnostic data.

4. The device according to claim 1, wherein the securing unit is configured to calculate the session keys independently of the operation of the computing unit.

5. The device according to claim 4, wherein the securing unit is configured to calculate the session keys during generation of the diagnostic data.

6. The device according to claim 1, wherein the device has a memory that is configured to store the session keys for securing the diagnostic data, and
wherein the securing unit is configured to read out the session keys from the memory independently of the operation of the computing unit.

7. The device according to claim 6, wherein the securing unit is configured to calculate the session keys before a start of generation of the diagnostic data to be secured and to store them in the memory.

8. The device according to claim 1, wherein the securing unit is configured to encrypt the diagnostic data using incrementally generated values of a limited number range, and
wherein the securing unit is configured to perform a change between session keys before or when the incrementally generated values reach an end of the limited number range or would exceed the end of the limited number range using the incrementation.

9. The device according to claim 8, wherein the values are nonces in the form of time stamps of the diagnostic data.

10. The device according to one of claim 1, wherein the device is part of a media access control security hardware architecture.

11. Device The device according to claim 1, wherein the device or at least the securing unit is formed as a hardware structure that can be operated separately from a media access control security hardware architecture.

12. The device according to claim 1, wherein the interface is configured to obtain information about a duration and/or a data amount of the diagnostic data, and
wherein the securing unit is configured to determine the session keys based on the information about the duration and/or data amount of the diagnostic data.

13. The device according to claim 1, wherein the securing unit is configured to determine the session keys based on a long-term key.

14. The device according to claim 1, wherein the securing unit is configured to determine the session keys based on a key determination method.

15. The device according to claim 1, wherein the device and the computing unit are implemented on a common system on chip.

16. The device according to claim 15, wherein the common system on chip is part of an electronic control unit.

17. Device The device according to claim 1, wherein the interface has an Ethernet interface to output the secured diagnostic data.

18. The device according to claim 1, wherein the interface is configured to provide the computing unit with a signal for a start of recording of the diagnostic data.

19. The device according to claim 18, wherein the interface is configured to obtain, from a debug interface, information relating to the start of the recording of the diagnostic data;
a configuration of the diagnostic data;
a content of the diagnostic data; and/or a type of diagnostic data.

20. A method for securing diagnostic data relating to an operation of a computing unit the method comprising:
obtaining the diagnostic data of the computing unit using an interface and
securing the diagnostic data using session keys and providing a change between the session keys, independently of the operation of the computing unit, using a securing unit that is formed as a hardware structure that is operated separately from the computing unit.

21. A non-transitory computer-readable medium comprising a computer program having a program code for causing a computer system to perform a method for securing diagnostic data relating to an operation of a computing unit, the method comprising:
obtaining the diagnostic data of the computing unit using an interface; and
securing the diagnostic data using session keys and providing a change between the session keys, independently of the operation of the computing unit, using a securing unit that is formed as a hardware structure that is operated separately from the computing unit.
